(19) United States
(12) Patent Application Publication
(10) Pub. No.: US 2026/0186355 A1
(43) Pub. Date: Jul. 2, 2026

(54) ELECTRONIC DEVICE

(71) Applicant: InnoLux Corporation, Miao-Li County (TW)

(72) Inventors: I-An YAO, Miao-Li County (TW); Jiunn-Shyong LIN, Miao-Li County (TW); Wei-Cheng LEE, Miao-Li County (TW)

(21) Appl. No.: 19/401,556

(22) Filed: Nov. 26, 2025

(30) Foreign Application Priority Data
Dec. 26, 2024 (CN) 202411933657.3

(51) Int. Cl. G02F 1/1347; G02F 1/1335; G02F 1/137; G02F 1/157

(52) U.S. Cl. CPC G02F 1/13473; G02F 1/133512; G02F 1/133524; G02F 1/13718; G02F 1/157; G02F 2201/343

(57) ABSTRACT

An electronic device includes a reflective panel, a transmittance switching element and a light absorbing element. The reflective panel has a first side and a second side opposite to each other. The transmittance switching element is disposed on the first side of the reflective panel. The light absorbing element is disposed on the second side of the reflective panel. The reflective panel includes at least one cholesteric liquid crystal layer, and the at least one cholesteric liquid crystal layer is used to reflect visible light in a reflective state.

### CROSS-REFERENCE TO RELATED APPLICATIONS

This application claims the benefits of the Chinese Patent Application Serial Number 202411933657.3, filed on Dec. 26, 2024, the subject matter of which is incorporated herein by reference.

### BACKGROUND

### Field of the Disclosure

The present disclosure provides an electronic device, particularly an electronic device with high contrast.

### Description of Related Art

With the continuous development of science and technology, electronic devices are designed towards high contrast, low energy consumption, high quality or low cost. Common reflective electronic devices use cholesteric liquid crystals, which have advantages such as low power consumption due to their bistable characteristics, and they may include multiple layers of cholesteric liquid crystal panels stacked together to reflect different colors. However, current reflective electronic devices have defects such as low contrast and poor visual effect.

Therefore, there is an urgent need to provide an improved electronic device to alleviate and/or obviate the above defects.

### SUMMARY

The present disclosure provides an electronic device, which includes: a reflective panel having a first side and a second side opposite to each other; a transmittance switching element disposed on the first side of the reflective panel; and a light absorbing element disposed on the second side of the reflective panel, wherein the reflective panel includes at least one cholesteric liquid crystal layer, and the at least one cholesteric liquid crystal layer is used to reflect visible light in a reflective state.

Other novel features of the disclosure will become more apparent from the following detailed description when taken in conjunction with the accompanying drawings.

### BRIEF DESCRIPTION OF DRAWINGS

FIG. 1 is a cross-sectional schematic diagram of an electronic device according to an embodiment of the present disclosure;

FIG. 2 is a diagram showing the corresponding relationship between a plurality of pixel areas of a reflective panel and a plurality of control areas of a transmittance switching element according to an embodiment of the present disclosure;

FIG. 3 is a schematic diagram of the control relationship of an electronic device according to an embodiment of the present disclosure;

FIG. 4 is a schematic diagram illustrating the driving method of an electronic device according to an embodiment of the present disclosure;

FIG. 5 is a cross-sectional schematic diagram of an electronic device according to another embodiment of the present disclosure;

FIG. 6 is a cross-sectional schematic diagram of an electronic device according to yet another embodiment of the present disclosure.

FIG. 7 is a cross-sectional schematic diagram of an electronic device according to yet another embodiment of the present disclosure;

FIG. 8 is a cross-sectional schematic diagram of an electronic device according to yet another embodiment of the present disclosure;

FIG. 9 is a cross-sectional schematic diagram of an electronic device according to yet another embodiment of the present disclosure; and

FIG. 10 is a cross-sectional schematic diagram of an electronic device according to yet another embodiment of the present disclosure.

### DETAILED DESCRIPTION OF EMBODIMENT

The electronic device according to the embodiment of the present disclosure is described in detail below. It should be understood that the following description provides many different embodiments for implementing different aspects of some embodiments of the present disclosure. The specific components and arrangements described below are only for the purpose of simply and clearly describing some embodiments of the present disclosure. Of course, these are only examples and are not limitations of the present disclosure. In addition, similar and/or corresponding reference numerals may be used in different embodiments to identify similar and/or corresponding components in order to clearly describe the present disclosure. However, the use of these similar and/or corresponding reference numerals is only for simply and clearly describing some embodiments of the present disclosure, and does not represent any relationship between the different embodiments and/or structures discussed.

The embodiments of the present disclosure may be understood together with the drawings, and the drawings of the present disclosure are also regarded as part of the disclosure description. It should be understood that the drawings of the present disclosure are not in scale and, in fact, the dimensions of elements may be arbitrarily enlarged or reduced in order to clearly illustrate features of the present disclosure. In addition, directional terms mentioned in the present disclosure, such as “up”, “down”, “front”, “rear”, “left”, “right”, etc., only refer to the directions of the drawings. Accordingly, the directional term used is illustrative, not limiting, of the present disclosure. In the drawings, various figures illustrate the general characteristics of methods, structures and/or materials used in particular embodiments. However, these drawings should not be construed to define or limit the scope or nature encompassed by these embodiments. For example, the relative sizes, thicknesses and positions of various layers, regions and/or structures may be reduced or enlarged for clarity.

One structure (or layer, component, substrate) described in the present disclosure is disposed on/above another structure (or layer, component, substrate), which can mean that the two structures are adjacent and directly connected, or can refer to two structures that are adjacent rather than directly connected. Indirect connection means that there is at least one intermediate structure (or intermediate layer, intermediate component, intermediate substrate, intermediate space) between the two structures, the lower surface of one structure is adjacent to or directly connected to the upper surface of the intermediate structure, and the upper surface of the other structure is adjacent to or directly connected to the lower surface of the intermediate structure. The intermediate structure may be a single-layer or multi-layer physical structure or a non-physical structure, which is not limited. In the present disclosure, when a certain structure is arranged “on” other structures, it may mean that a certain structure is “directly” on other structures, or it means that a certain structure is “indirectly” on other structures; that is, at least one structure is sandwiched, in between a certain structure and other structures.

In addition, it should be understood that, unless otherwise specified, the ordinal numbers used in the specification and claims, such as “first” and “second”, are intended to distinguish elements rather than disclose explicitly or implicitly that names of the elements bear the wording of the ordinal numbers. The ordinal numbers do not imply what order an element and another element are in terms of space, time or steps of a manufacturing method. Thus, what is referred to as a “first element” in the specification may be referred to as a “second element” in the claims.

In some embodiments of the present disclosure, terms such as “connection” and “interconnection” about joining and connecting, unless otherwise specified, may mean that two structures are in direct contact, or may also mean that two structures are not in direct contact, where other structures are placed between the two structures. Moreover, the terms about joining and connecting may include the situation that both structures are movable, or both structures are fixed. In addition, the term “electrical connection” or “coupling” includes any direct and indirect means of electrical connection.

In the description, the terms “almost”, “about”, “approximately” or “substantially” usually means within 10%, 5%, 3%, 2%, 1% or 0.5% of a given value or range. Unless otherwise defined, the term “range between the first value and the second value” indicates that the range includes the first value, the second value, and other values in between. Moreover, any two values or directions used for comparison may have certain errors. If the first value is equal to the second value, it implies that there may be an error of about 10% between the first value and the second value; if the first direction is perpendicular or “approximately” perpendicular to the second direction, the angle between the first direction and the second direction may be between 80 degrees and 100 degrees; if the first direction is parallel or “substantially” parallel to the second direction, the angle between the first direction and the second direction may be between 0 degrees and 10 degrees. In the present disclosure, the expressions “the given range is from the first value to the second value” and “the given range falls within the range from the first value to the second value” indicate that the given range includes the first value, the second value, and other values in between.

Furthermore, according to the embodiments of the present disclosure, an optical microscope (OM), a scanning electron microscope (SEM), an thin film thickness profiler (α-step), an ellipsometer, or other suitable methods may be used to measure the thickness, length, width of each component or the distance and angle between components. In detail, according to some embodiments, a scanning electron microscope may be used to obtain a cross-sectional image of a structure and measure the thickness, length, width of each component or the distance and angle between components.

In the entire specification and appended claims of the present disclosure, certain words are used to refer to specific components. Those skilled in the art should understand that electronic device manufacturers may refer to the same components by different names. The present disclosure does not intend to distinguish those components with the same function but different names. In the following description and claims, words such as “comprising”, “including”, and “having” are open type words, so they should be interpreted as meaning “including but not limited to”. Therefore, when the terms “comprising”, “including” and/or “having” are used in the description of the present disclosure, they specify the existence of corresponding features, regions, steps, operations and/or components, but do not exclude the existence of one or more corresponding features, regions, steps, operations and/or components.

It should be noted that the following embodiments may be replaced, reorganized, and mixed with features of several different embodiments to complete other embodiments without departing from the spirit of the present disclosure. Features in various embodiments may be mixed and matched as long as they do not violate the spirit of the disclosure or conflict with each other.

Unless otherwise defined, all terms (including technical and scientific terms) used herein have the same meaning as commonly understood by one of ordinary skill in the art to which this disclosure belongs. It may be understood that these terms, such as those defined in commonly used dictionaries, should be interpreted as having meanings consistent with the background or context of the related technology and the present disclosure, and should not be interpreted in an idealized or overly formal manner, unless otherwise specified in the embodiments of the present disclosure. The present disclosure may be understood by referring to the following detailed description in conjunction with the accompanying drawings. It should be noted that, in order to facilitate the understanding of the readers and for the simplicity of the drawings, the multiple drawings in the present disclosure only depict a portion of the electronic device, and the specific components in the drawings are not drawn according to the actual scale. In addition, the number and size of each component in the figure are only for illustration and are not intended to limit the scope of the present disclosure.

The electronic device of the present disclosure may include electronic components. The electronic components may include passive components, active components or a combination thereof, such as capacitors, resistors, inductors, varactor diodes, variable capacitors, filters, diodes, transistors, sensors, micro-electromechanical system (MEMS) components, liquid crystal chips, etc., but not limited thereto. The diode may include a light-emitting diode or a non-light-emitting diode. The diode includes a P-N junction diode, a PIN diode or a constant current diode. The light-emitting diode may include, for example, an organic light emitting diode (OLED), a sub-millimeter light-emitting diode (mini LED), a micro LED, a quantum dot light-emitting diode (quantum dot LED), fluorescence, phosphor or other suitable materials, or a combination thereof, but not limited thereto. The sensor may include, for example, capacitive sensors, optical sensors, electromagnetic sensors, fingerprint sensors (FPS), touch sensors, antennas, or pen sensors, but not limited thereto. The following description will use a display device as an electronic device to illustrate the present disclosure, but the present disclosure is not limited thereto.

The electronic device may include an imaging device, a bonding device, a display device, a backlight device, an antenna device, a tiled device, a touch display, a curved display, or a free shape display, but not limited thereto. The electronic device may, for example, include a liquid crystal, a light emitting diode, fluorescence, phosphor, other suitable display media, or a combination thereof, but not limited thereto. The display device may be a non-self-luminous display device or a self-luminous display device. The antenna device may be a liquid crystal antenna device or a non-liquid crystal antenna device, and the sensing device may be a sensing device for sensing capacitance, light, heat, or ultrasound, but not limited thereto. The tiled device may, for example, be a display tiled device or an antenna tiled device, but not limited thereto. It should be noted that the electronic device may be any combination of the foregoing, but not limited thereto. The electronic device may be a bendable or flexible electronic device. It should be noted that the electronic device may be any arrangement or combination of the aforementioned, but not limited thereto. In addition, the appearance of the electronic device may be rectangular, circular, polygonal, a shape with curved edges, or other suitable shapes. The electronic device may have a peripheral system, such as a drive system, a control system, a light source system, a shelf system, etc., to support a display device, an antenna device, or a tiled device. It should be noted that the following embodiments may replace, reorganize, and mix the features of several different embodiments to complete other embodiments without departing from the spirit of the present disclosure. The features of each embodiment may be mixed and matched as long as they do not violate the spirit of the disclosure or conflict with each other. It should be noted that the technical solutions provided in different embodiments below may be replaced, combined, or mixed with each other to form another embodiment without violating the spirit of the present disclosure.

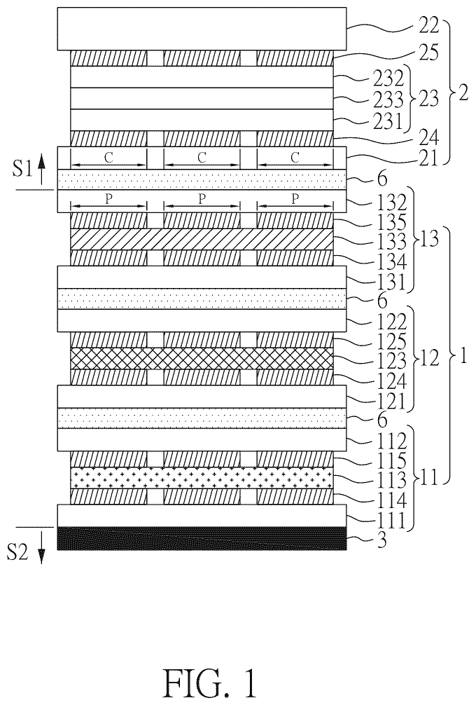

FIG. 1 is a cross-sectional schematic diagram of an electronic device according to an embodiment of the present disclosure. FIG. 1 shows a display area of the electronic device according to the present disclosure, but does not show a non-display area. In one embodiment of the present disclosure, as shown in FIG. 1, the electronic device includes a reflective panel 1, a transmittance switching element 2, and a light absorbing element 3. The reflective panel 1 has a first side S1 and a second side S2 opposite to each other. The transmittance switching element 2 is disposed on the first side S1 of the reflective panel 1, and the light absorbing element 3 is disposed on the second side S2 of the reflective panel 1. Specifically, the reflective panel 1 is disposed between the transmittance switching element 2 and the light absorbing element 3. The reflective panel 1 includes at least one cholesteric liquid crystal layer (for example, a first cholesteric liquid crystal layer 113, a second cholesteric liquid crystal layer 123, or a third cholesteric liquid crystal layer 133), and the at least one cholesteric liquid crystal layer is used to reflect visible light in a reflective state. Here, the cholesterol liquid crystal layer may drive the arrangement of the cholesterol liquid crystal layer according to the electric field generated by the voltage applied between the corresponding electrode layers, thereby changing its state (for example, a reflective state (that is, a planar state), a transmissive state (focal conic state), or a homeotropic state. Taking an electronic device having a single cholesterol liquid crystal layer as an example, when the cholesterol liquid crystal layer is in the reflective state, it may be used to reflect visible light, thereby allowing the electronic device to display visible light, such as red, blue, or green visible light, but the present disclosure is not limited thereto; when the cholesterol liquid crystal layer is in the transmissive state, because the bottom layer is a light absorbing element 3 (for example, a black absorbing element), the electronic device displays black.

In the present disclosure, the reflective panel 1 includes a first sub-panel 11 and a second sub-panel 12. The first sub-panel 11 includes a first substrate 111, a second substrate 112, a first cholesteric liquid crystal layer 113, a first electrode layer 114 and a second electrode layer 115. The first cholesteric liquid crystal layer 113 is disposed between the first substrate 111 and the second substrate 112. The first electrode layer 114 is disposed between the first substrate 111 and the first cholesteric liquid crystal layer 113. The second electrode layer 115 is disposed between the first cholesteric liquid crystal layer 113 and the second substrate 112. The second sub-panel 12 is disposed on the first sub-panel 11, and includes a third substrate 121, a fourth substrate 122, a second cholesteric liquid crystal layer 123, a third electrode layer 124 and a fourth electrode layer 125. The second cholesteric liquid crystal layer 123 is disposed between the third substrate 121 and the fourth substrate 122. The third electrode layer 124 is disposed between the third substrate 121 and the second cholesteric liquid crystal layer 123. The fourth electrode layer 125 is disposed between the second cholesteric liquid crystal layer 123 and the fourth substrate 122. The first cholesteric liquid crystal layer 113 and the second cholesteric liquid crystal layer 123 are respectively used to reflect visible light of different colors in the reflective state, for example, red visible light and green visible light, respectively, but the present disclosure is not limited thereto, and the aforementioned cholesteric liquid crystal layers are respectively used to reflect visible light of other suitable colors in the reflective state. In addition, an adhesive layer 6 may be selectively disposed between the first sub-panel 11 and the second sub-panel 12 to bond the first sub-panel 11 and the second sub-panel 12. In other embodiments (not shown), the first sub-panel 11 and the second sub-panel 12 may also share a substrate on one side; that is, the second substrate 112 and the third substrate 121 may be the same substrate, and the adhesive layer 6 may be omitted in this case.

In the present disclosure, the reflective panel 1 may further include a third sub-panel 13, wherein the second sub-panel 12 is disposed between the first sub-panel 11 and the third sub-panel 13, and an adhesive layer 6 may be selectively disposed between the second sub-panel 12 and the third sub-panel 13 to adhere the second sub-panel 12 and the third sub-panel 13. The third sub-panel 13 includes a fifth substrate 131, a sixth substrate 132, a third cholesteric liquid crystal layer 133, a fifth electrode layer 134, and a sixth electrode layer 135, wherein the third cholesteric liquid crystal layer 133 is disposed between the fifth substrate 131 and the sixth substrate 132, the fifth electrode layer 134 is disposed between the fifth substrate 131 and the third cholesteric liquid crystal layer 133, and the sixth electrode layer 135 is disposed between the third cholesteric liquid crystal layer 133 and the sixth substrate 132. The first cholesterol liquid crystal layer 113, the second cholesterol liquid crystal layer 123 and the third cholesterol liquid crystal layer 133 are respectively used to reflect visible light of different colors in the reflective state, for example, red visible light, green visible light and blue visible light, but the present disclosure is not limited thereto, and the aforementioned cholesterol liquid crystal layers are respectively used to reflect visible light of other suitable colors in the reflective state. Similarly, in other embodiments (not shown), the second sub-panel 12 and the third sub-panel 13 may also share a substrate on one side; that is, the fourth substrate 122 and the fifth substrate 131 may be the same substrate, and the adhesive layer 6 may be omitted in this case.

In one embodiment of the present disclosure, the first sub-panel 11 may be, for example, a display panel for reflecting red visible light, the second sub-panel 12 may be, for example, a display panel for reflecting green visible light, and the third sub-panel 13 may be, for example, a display panel for reflecting blue visible light, but the present disclosure is not limited thereto. The reflection colors of the first sub-panel 11, the second sub-panel 12, and the third sub-panel 13 may be adjusted as required. In other embodiments, the electronic device may selectively have fewer or more display panels, each for reflecting a different color.

In the present disclosure, an adhesive layer 6 may be selectively disposed between the transmittance switching element 2 and the reflective panel 1 to adhere the transmittance switching element 2 and the reflective panel 1. The transmittance switching element 2 includes a seventh substrate 21, an eighth substrate 22, a control layer 23, a seventh electrode layer 24 and an eighth electrode layer 25, wherein the control layer 23 is disposed between the seventh substrate 21 and the eighth substrate 22 and between the seventh electrode layer 24 and the eighth electrode layer 25, the seventh electrode layer 24 is disposed between the seventh substrate 21 and the control layer 23, and the eighth electrode layer 25 is disposed between the control layer 23 and the eighth substrate 22. The control layer 23 may include an electrochromic material. More specifically, the control layer 23 includes an ion storage layer 231, an electrochromic layer 232, and an electrolyte layer 233, wherein the electrolyte layer 233 is disposed between the ion storage layer 231 and the electrochromic layer 232, the ion storage layer 231 is disposed between the seventh electrode layer 24 and the electrolyte layer 233, and the electrochromic layer 232 is disposed between the electrolyte layer 233 and the eighth electrode layer 25, but the present disclosure is not limited thereto. In another embodiment of the present disclosure, the positions of the ion storage layer 231 and the electrochromic layer 232 may be interchanged; that is, the electrochromic layer 232 is disposed between the seventh electrode layer 24 and the electrolyte layer 233, and the ion storage layer 231 is disposed between the electrolyte layer 233 and the eighth electrode layer 25. In this embodiment, the control layer 23 is exemplified as a whole-surface design, and the whole-surface design means that the ion storage layer 231, the electrochromic layer 232, and/or the electrolyte layer 233 are each an integral film layer. The whole-surface design is, for example, that each of the ion storage layer 231, the electrochromic layer 232 and the electrolyte layer 233 of the control layer 23 in different control areas C is in integral connection. In other embodiments (not shown), each of the ion storage layer 231, the electrochromic layer 232 and the electrolyte layer 233 of the control layer 23 in different control areas C may be divided to be separated and not in integral connection.

In the present disclosure, the ion storage layer 231 is used to store ions and supply the required ions during the color change process to achieve the effect of balancing the total amount of charge in the electronic device. The electrochromic layer 232 includes an electrochromic material with electrochromic properties. For example, the electrochromic material may include an inorganic electrochromic material (such as CeO₂—TiO₂, NiOₓ, WO₃, MnO₂, etc.) or an organic electrochromic material (such as bipyridyl salts, conductive polymers, metal organic polymers or metal phthalocyanines, polyimide polymers, etc.) or a suitable combination of the above, but the present disclosure is not limited thereto. The ion storage layer 231 may use an electrochromic material with properties opposite to the electrochromic layer 232 to achieve the effect of color superposition or complementation. For example, the ion storage layer 231 uses a cathode reduction chromic material, and the electrochromic layer 232 uses an anode reduction chromic material, but the present disclosure is not limited thereto, and the ion storage layer 231 may use an anode reduction chromic material, and the electrochromic layer 232 may use a cathode reduction chromic material. Furthermore, the electrolyte layer 233 is used to provide a channel for ions to be transmitted between the ion storage layer 231 and the electrochromic layer 232, and the electrolyte layer 233 may be prepared by using, for example, a high molecular polymer solid electrolyte material, but the present disclosure is not limited thereto.

In the present disclosure, the material of the light absorbing element 3 may include a (black) ink layer, a (black) resin layer, an anti-reflective material or a suitable light absorbing material, but the present disclosure is not limited thereto. When the cholesteric liquid crystal layers stacked thereon (that is, the first cholesteric liquid crystal layer 113, the second cholesteric liquid crystal layer 123 and the third cholesteric liquid crystal layer 133) are in a transmissive state, they may be used to absorb visible light to make the electronic device display black. In this embodiment, the light absorbing element 3 is, for example, disposed under the reflective panel 1, but it is not limited thereto. In other embodiments, the light absorbing element 3 may also be disposed between the first cholesteric liquid crystal layer 113 and the first substrate 111.

In the present disclosure, the first substrate 111, the second substrate 112, the third substrate 121, the fourth substrate 122, the fifth substrate 131, the sixth substrate 132, the seventh substrate 21 and/or the eighth substrate 22 may include a rigid substrate, a soft substrate or a flexible substrate. The materials of the first substrate 111, the second substrate 112, the third substrate 121, the fourth substrate 122, the fifth substrate 131, the sixth substrate 132, the seventh substrate 21 and/or the eighth substrate 22 may be the same or different. The materials of the first substrate 111, the second substrate 112, the third substrate 121, the fourth substrate 122, the fifth substrate 131, the sixth substrate 132, the seventh substrate 21 and/or the eighth substrate 22 may each include glass, quartz, sapphire, ceramic, plastic, polycarbonate (PC), polyimide (PI), polypropylene (PP), polyethylene terephthalate (PET), polymethylmethacrylate (PMMA), other suitable materials or a combination thereof, but the present disclosure is not limited thereto. When the first substrate 111, the second substrate 112, the third substrate 121, the fourth substrate 122, the fifth substrate 131, the sixth substrate 132, the seventh substrate 21 and the eighth substrate 22 are flexible substrates, the electronic device of the present disclosure may be a flexible display device.

In the present disclosure, although not shown in the figures, active components (for example, transistors), conductive wires (not shown), alignment layers (not shown), insulating layers (not shown) or a combination thereof may be selectively provided on the first substrate 111, the second substrate 112, the third substrate 121, the fourth substrate 122, the fifth substrate 131, the sixth substrate 132, the seventh substrate 21 and the eighth substrate 22, but the present disclosure is not limited thereto.

In the present disclosure, the materials of the first electrode layer 114, the second electrode layer 115, the third electrode layer 124, the fourth electrode layer 125, the fifth electrode layer 134, the sixth electrode layer 135, the seventh electrode layer 24 and/or the eighth electrode layer 25 may be the same or different from each other. The materials of the first electrode layer 114, the second electrode layer 115, the third electrode layer 124, the fourth electrode layer 125, the fifth electrode layer 134, the sixth electrode layer 135, the seventh electrode layer 24 and/or the eighth electrode layer 25 may each include a transparent conductive material (for example, indium zinc oxide (IZO), indium tin oxide (ITO), indium tin zinc oxide (ITZO), indium gallium zinc oxide (IGZO), aluminum zinc oxide (AZO)) or a combination thereof, but the present disclosure is not limited thereto.

In the present disclosure, the material of the adhesive layer 6 may include, for example, polyvinyl butyral (PVB), ethylene vinyl acetate (EVA), optical clear adhesive (OCA), optical clear resin (OCR), other suitable materials or a combination thereof, but the present disclosure is not limited thereto.

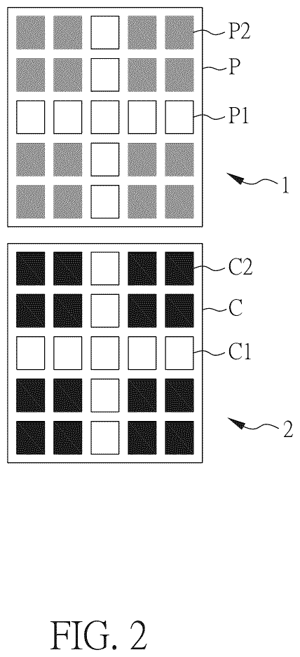

FIG. 2 is a diagram showing the correspondence between a plurality of pixel areas of a reflective panel and a plurality of control areas of a transmittance switching element according to an embodiment of the present disclosure. FIG. 2 shows the display area of the electronic device of the present disclosure, but does not show the non-display area. Here, for the convenience of explanation, the reflective panel 1 and the transmittance switching element 2 are not presented in a stacked manner and, in fact, the reflective panel 1 and the transmittance switching element 2 have a stacked structure as shown in FIG. 1. In one embodiment of the present disclosure, as shown in FIG. 1 and FIG. 2, the reflective panel 1 includes a plurality of pixel areas P, the transmittance switching element 2 includes a plurality of control areas C, and the plurality of pixel areas P overlap the plurality of control areas C, respectively. Specifically, the plurality of pixel areas P of the reflective panel 1 overlap and correspond to the plurality of control areas C of the transmittance switching element 2, respectively. For example, when displaying an image, a first portion P1 of the plurality of pixel areas P may be switched to a reflective state (that is, representing a bright state area (image area)), a second portion P2 of the plurality of pixel areas P may be switched to a transmissive state (that is, representing a dark state area), a portion C1 of the plurality of control areas C overlapping the first portion P1 may be switched to a transmissive state, and another portion C2 of the plurality of control areas C overlapping the second portion P2 may be switched to a non-transmissive state to reduce the brightness of the dark state area. Since the contrast of an electronic device is calculated by the ratio of the brightness of the bright state to the brightness of the dark state, the contrast of the electronic device may be greatly improved by reducing the brightness in the dark state, thereby achieving a better display effect. For example, the brightness of the reflective state (that is, representing the bright state area (image area)) of the reflective panel 1 is 30%, the brightness of the transmissive state (that is, representing the dark state area) of the reflective panel 1 is 6%, the visible light transmittance of the transmissive state of the transmittance switching element 2 is 80%, and the visible light transmittance of the non-transmissive state of the transmittance switching element 2 is 2% to 7%, the contrast of the electronic device is about 200 (30%×0.8/6%×0.02) to 57 (30%×0.8/6%×0.07), wherein the above values are only examples, and may be designed differently according to different embodiments. In some embodiments, the number of pixel areas P of the reflective panel 1 may be substantially the same as the number of control areas C of the transmittance switching element 2. In some embodiments (not shown), the number of pixel areas P of the reflective panel 1 may be different from the number of control areas C of the transmittance switching element 2; for example, the number of pixel areas P may be less than or greater than the number of control areas C of the transmittance switching element 2.

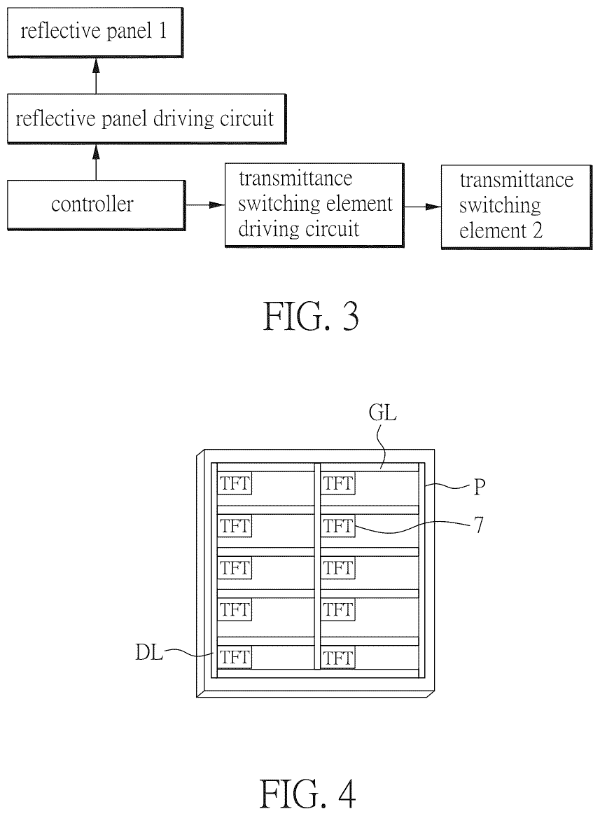

FIG. 3 is a schematic diagram of the control relationship of an electronic device according to an embodiment of the present disclosure. FIG. 4 is a schematic diagram of an active matrix driving circuit of an electronic device according to an embodiment of the present disclosure. In one embodiment of the present disclosure, as shown in FIG. 1 and FIG. 3, the electronic device may further include a controller for controlling the driving circuit of the reflective panel 1 and the driving circuit of the transmittance switching element 2, respectively, so as to drive the reflective panel 1 and the transmittance switching element 2, respectively. As shown in FIG. 1 and FIG. 4, the driving method of the reflective panel 1 and the transmittance switching element 2 in the electronic device may be performed by an active matrix driving circuit, but the present disclosure is not limited thereto. In other embodiments of the present disclosure, the driving method of the electronic device may also be performed by a passive matrix driving circuit. Taking the reflective panel 1 as an example, the active matrix driving circuit means that each pixel in the plurality of pixel areas P of the reflective panel 1 has its corresponding independent driving circuit, for example, including a transistor 7 electrically connected to a signal line (for example, a scanning line GL and a data line DL) or respective electrodes to drive the arrangement of the cholesterol liquid crystal layer in each pixel, and the driving current of each pixel is provided by its corresponding transistor 7. The passive matrix driving circuit means that each row of pixels of the reflective panel 1 is connected to a row scanning line, and each column of pixels of the reflective panel 1 is connected to a column scanning line. When the X-th column scanning line and the Y-th row scanning line are turned on, the pixel at the intersection (X, Y) will be lit, thereby displaying an image through a high-speed point-by-point scanning method. The active or passive driving method of the control area C of the transmittance switching element 2 may be similar to that of the pixel area P of the reflective panel 1, and thus a detailed description is deemed unnecessary.

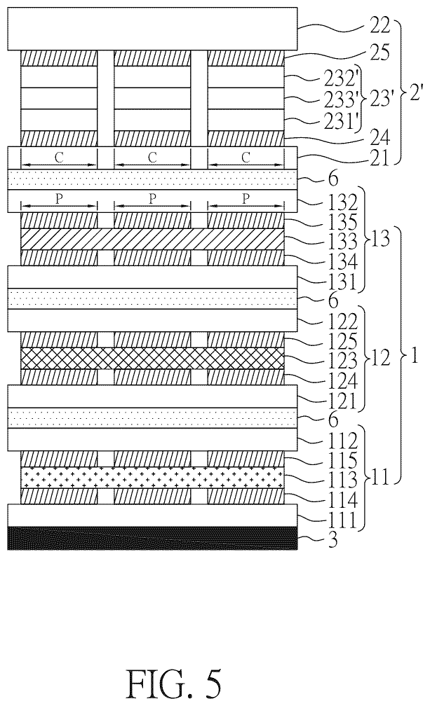

FIG. 5 is a cross-sectional schematic diagram of an electronic device according to another embodiment of the present disclosure. Since some features of the embodiment of FIG. 5 are applicable to the description of the embodiments of FIG. 1 to FIG. 4, they are not described in detail, and the following mainly focuses on the differences. Compared with the embodiments of FIG. 1 to FIG. 4, the control layer 23′ of the transmittance switching element 2′ according to the embodiment of FIG. 5 is a pixelated design. Here, the pixelated design means that each of the ion storage layer 231′, the electrochromic layer 232′ and/or the electrolyte layer 233′ is arranged with a plurality of portions each corresponding to one pixel area P, rather than the integral film layer.

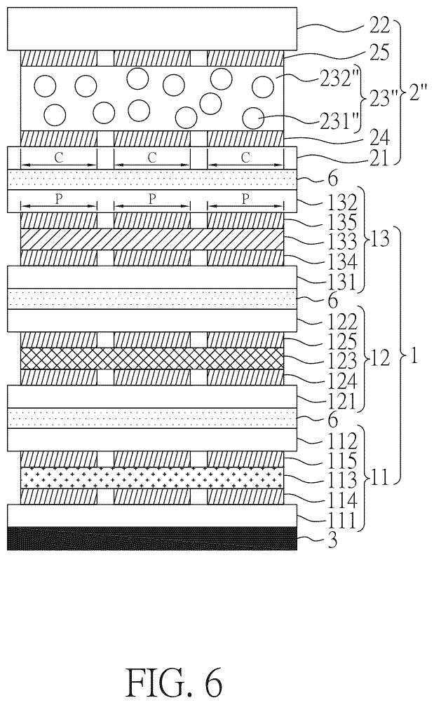

FIG. 6 is a cross-sectional schematic diagram of an electronic device according to yet another embodiment of the present disclosure. Since some features of the embodiment of FIG. 6 are applicable to the description of the embodiments of FIG. 1 to FIG. 4, they are not described in detail, and the following mainly focuses on the differences. Compared with the embodiments of FIG. 1 to FIG. 4, the control layer 23″ of the transmittance switching element 2″ of the embodiment of FIG. 6 may include suspended particles 231″. More specifically, the control layer 23″ includes suspended particles 231″ and/or organic gel 232″. The suspended particles 231″ are, for example, uniformly dispersed and suspended in the organic gel 232″. When power is applied, the suspended particles 231″ of the control layer 23″ are, for example, regularly arranged along the direction of the electric field, so that part of the light may pass through. Therefore, the transmittance switching element 2″ is in a partially transmissive state, for example, about 50% transmissive state, but it is not limited thereto. When power is not applied, the suspended particles 231″ of the control layer 23″ are irregularly arranged, and light cannot pass through. Therefore, the transmittance switching element 2″ is in a non-transmissive state. In other words, if the transmittance switching element 2″ is to be switched to the transmissive state, it must be powered on; conversely, if the transmittance switching element 2″ is to be switched to the non-transmissive state, it does not need to be powered on. In addition, the driving method of the electronic device of the embodiment of FIG. 6 may also be performed by an active matrix driving circuit or a passive matrix driving circuit, which is described above and will not be described in detail.

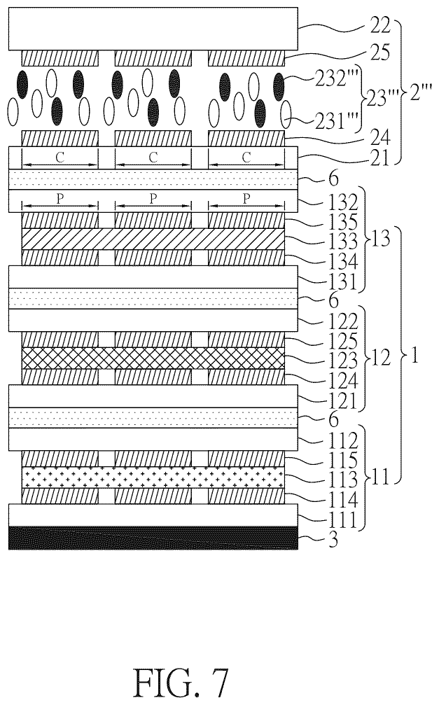

FIG. 7 is a cross-sectional schematic diagram of an electronic device according to yet another embodiment of the present disclosure. Since some features of the embodiment of FIG. 7 are applicable to the description of the embodiments of FIG. 1 to FIG. 4, they will not be described in detail, and the following mainly focuses on the differences. Compared with the embodiments of FIG. 1 to FIG. 4, the control layer 23″′ of the transmittance switching element 2″′ of the embodiment of FIG. 7 may include a dye liquid crystal. More specifically, the control layer 23″′ includes a liquid crystal 231″′ and a dye 232″′. Taking the liquid crystal 231″′ as a negative liquid crystal as an example, when power is applied, the long axis direction of the liquid crystal 231″′ and the dye 232″′ may be, for example, roughly perpendicular to the direction of the electric field, so that the dye 232″′ absorbs more light, and thus the transmittance switching element 2″′ is in a non-transmissive state; when power is not applied, the long axis direction of the liquid crystal 231″′ and the dye 232″′ may be, for example, roughly parallel to the direction of the electric field, the dye 232″′ absorbs less light, and most of the light is able to pass through the control layer 23″, so that the transmittance switching element 2″′ is in a transmissive state. However, the present disclosure is not limited thereto, and the liquid crystal 231″′ may also be a positive liquid crystal. In addition, the driving method of the electronic device of the embodiment of FIG. 7 may also be performed by an active matrix driving circuit or a passive matrix driving circuit, which is described above and will not be described in detail.

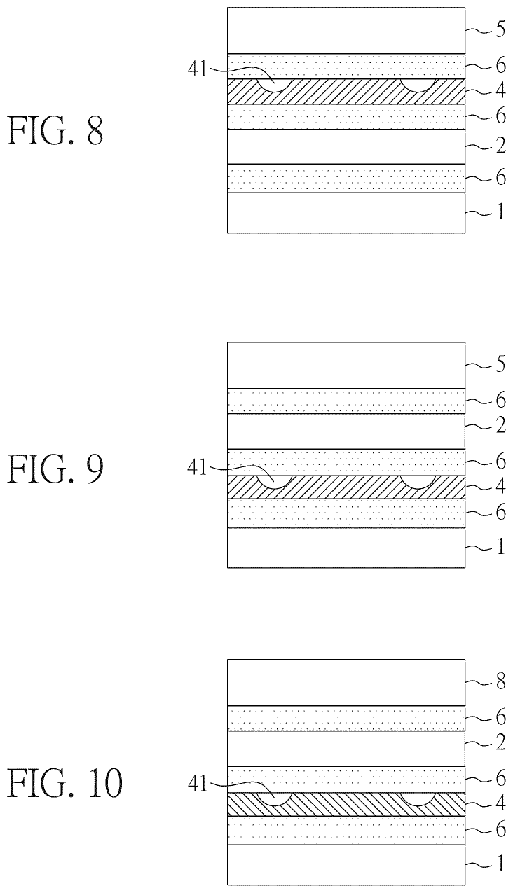

FIG. 8 is a cross-sectional schematic diagram of an electronic device according to yet another embodiment of the present disclosure. In one embodiment of the present disclosure, as shown in FIG. 8, the electronic device may further include a light guide plate 4 and a touch layer 5. The light guide plate 4 may be disposed on one side of the transmittance switching element 2 away from the reflective panel 1, the touch layer 5 may be disposed on the transmittance switching element 2, and the touch layer 5 may be disposed on the light guide plate 4. The light guide plate 4 may be disposed between the transmittance switching element 2 and the touch layer 5. The transmittance switching element 2 may be disposed between the reflective panel 1 and the light guide plate 4. The light guide plate 4 may include, for example, a plurality of dots 41, but the present disclosure is not limited thereto, and the light guide plate 4 may also include a plurality of microstructures. In addition, the transmittance switching element 2 of the embodiment of FIG. 8 may also be replaced by any one of the aforementioned transmittance switching elements 2′, 2″, 2″′.

In the present disclosure, although not shown in the figures, a protective substrate may be selectively provided on the touch layer 5, and the protective substrate may be subject to anti-reflection or anti-glare process. Alternatively, the protective substrate may be additionally provided with an anti-glare film or an anti-reflection film. In addition, adhesive layers 6 may be provided between the reflective panel 1 and the transmittance switching element 2, between the transmittance switching element 2 and the light guide plate 4, and between the light guide plate 4 and the touch layer 5, respectively. In other embodiments, similar to the embodiment of FIG. 8, the main difference is that the electronic device may not include the light guide plate 4. In one embodiment, similar to the embodiment of FIG. 8, the main difference is that the electronic device may not include the light guide plate 4 and the touch layer 5.

FIG. 9 is a cross-sectional schematic diagram of an electronic device according to yet another embodiment of the present disclosure. In one embodiment of the present disclosure, as shown in FIG. 9, the electronic device may further include a light guide plate 4 and a touch layer 5, wherein the light guide plate 4 may be disposed between the transmittance switching element 2 and the reflective panel 1, the touch layer 5 may be disposed on the transmittance switching element 2, and the transmittance switching element 2 may be disposed between the light guide plate 4 and the touch layer 5. The light guide plate 4 may include a plurality of dots 41, but the present disclosure is not limited thereto, and the light guide plate 4 may also include a plurality of microstructures. In addition, the transmittance switching element 2 of the embodiment of FIG. 9 may also be replaced by any one of the aforementioned transmittance switching elements 2′, 2″, 2″′.

In the present disclosure, although not shown in the figures, a protective substrate may be selectively disposed on the touch layer 5, and the protective substrate may be subject to anti-reflection or anti-glare process. Alternatively, an anti-glare film or anti-reflection film may be additionally disposed on the protective substrate. In addition, adhesive layers 6 may be provided between the reflective panel 1 and the transmittance switching element 2, between the transmittance switching element 2 and the light guide plate 4, and between the light guide plate 4 and the touch layer 5, respectively.

FIG. 10 is a cross-sectional schematic diagram of an electronic device according to yet another embodiment of the present disclosure.

In one embodiment of the present disclosure, as shown in FIG. 10, the electronic device may further include a light guide plate 4 and a protective substrate 8, wherein the protective substrate 8 may be disposed on the reflective panel 1, the transmittance switching element 2 may be disposed between the reflective panel 1 and the protective substrate 8, the light guide plate 4 may be disposed between the transmittance switching element 2 and the reflective panel 1. The light guide plate 4 may include a plurality of dots 41, but the present disclosure is not limited thereto, and the light guide plate 4 may also include a plurality of microstructures. In addition, adhesive layers 6 may be provided between the reflective panel 1 and the transmittance switching element 2, between the transmittance switching element 2 and the light guide plate 4, and between the light guide plate 4 and the the protective substrate 8, respectively. In addition, the transmittance switching element 2 of the embodiment of FIG. 10 may also be replaced by any one of the aforementioned transmittance switching elements 2′, 2″, 2″′.

In other embodiments, similar to the embodiment of FIG. 10, the main difference is that the position of the light guide plate 4 and the position of the transmittance switching element 2 may be exchanged. In yet another embodiment, similar to the embodiment of FIG. 10, the main difference is that the electronic device may not include the light guide plate 4.

The aforementioned specific embodiments should be construed as merely illustrative, and not limiting the rest of the present disclosure in any way.

1. An electronic device, comprising:
a reflective panel having a first side and a second side opposite to each other;
a transmittance switching element disposed on the first side of the reflective panel; and
a light absorbing element disposed on the second side of the reflective panel, wherein the reflective panel includes at least one cholesteric liquid crystal layer, and the at least one cholesteric liquid crystal layer is used to reflect visible light in a reflective state.

2. The electronic device as claimed in claim 1, wherein the transmittance switching element includes a control layer, and the control layer includes one of an electrochromic material, suspended particles or dye liquid crystal.

3. The electronic device as claimed in claim 2, wherein the transmittance switching element includes an electrode layer and a further electrode layer, and the control layer is disposed between the electrode layer and the further electrode layer.

4. The electronic device as claimed in claim 1, further comprising a light guide plate disposed on one side of the transmittance switching element away from the reflective panel.

5. The electronic device as claimed in claim 1, further comprising a light guide plate disposed between the transmittance switching element and the reflective panel.

6. The electronic device as claimed in claim 1, further comprising a touch layer disposed on the transmittance switching element.

7. The electronic device as claimed in claim 1, wherein the reflective panel includes a plurality of pixel areas, the transmittance switching element includes a plurality of control areas, and the plurality of pixel areas overlap the plurality of control areas, respectively.

8. The electronic device as claimed in claim 7, wherein a first portion of the plurality of pixel areas is switched to the reflective state, a second portion of the plurality of pixel areas is switched to a transmissive state, wherein a portion of the plurality of control areas overlapping the first portion is switched to a transmissive state, and a further portion of the plurality of control areas overlapping the second portion is switched to a non-transmissive state.

9. The electronic device as claimed in claim 1, further comprising a controller for controlling a driving circuit of the reflective panel and a driving circuit of the transmittance switching element, respectively.

10. The electronic device as claimed in claim 1, wherein the reflective panel comprises:
a first sub-panel including a first cholesteric liquid crystal layer; and
a second sub-panel disposed on the first sub-panel and including a second cholesteric liquid crystal layer,
wherein the first cholesteric liquid crystal layer and the second cholesteric liquid crystal layer are respectively used to reflect visible light of different colors in the reflective state.

11. The electronic device as claimed in claim 10, wherein an adhesive layer is disposed between the first sub-panel and the second sub-panel.

12. The electronic device as claimed in claim 10, wherein the reflective panel further comprises:
a third sub-panel, wherein the second sub-panel is disposed between the first sub-panel and the third sub-panel, and the third sub-panel includes a third cholesteric liquid crystal layer,
wherein the first cholesteric liquid crystal layer, the second cholesteric liquid crystal layer and the third cholesteric liquid crystal layer are respectively used to reflect visible light of different colors in the reflective state.

13. The electronic device as claimed in claim 10, wherein an adhesive layer is disposed between the second sub-panel and the third sub-panel.

14. The electronic device as claimed in claim 1, wherein the at least one cholesteric liquid crystal layer includes a first cholesteric liquid crystal layer, a second cholesteric liquid crystal layer and a third cholesteric liquid crystal layer, and the first cholesteric liquid crystal layer, the second cholesteric liquid crystal layer and the third cholesteric liquid crystal layer are respectively used to reflect red visible light, green visible light and blue visible light in the reflective state.

15. The electronic device as claimed in claim 3, wherein the control layer includes an ion storage layer, an electrochromic layer and an electrolyte layer, the electrolyte layer is disposed between the ion storage layer and the electrochromic layer, the ion storage layer is disposed between the electrode layer and the electrolyte layer, and the electrochromic layer is disposed between the electrolyte layer and the further electrode layer.

16. The electronic device as claimed in claim 15, wherein the ion storage layer, the electrochromic layer and the electrolyte layer are each an integral film layer.

17. The electronic device as claimed in claim 4, wherein the light guide plate includes a plurality of dots or a plurality of microstructures.

18. The electronic device as claimed in claim 5, wherein the light guide plate includes a plurality of dots or a plurality of microstructures.

19. The electronic device as claimed in claim 1, further comprising a light guide plate and a protective substrate, wherein the protective substrate is disposed on the reflective panel, the transmittance switching element is disposed between the reflective panel and the protective substrate, and the light guide plate is disposed between the transmittance switching element and the reflective panel.

20. The electronic device as claimed in claim 19, wherein the light guide plate includes a plurality of dots or a plurality of microstructures.
